(19) United States
(12) Patent Application Publication
(10) Pub. No.: US 2008/0235798 A1
(43) Pub. Date: Sep. 25, 2008

(54) METHOD FOR FILTERING JUNK MESSAGES

(76) Inventor: Jian-De LU, Yujing Hsiang (TW)

Correspondence Address: Hershkovitz & Associates, LLC, 2845 Duke Street, Alexandria, VA, 22314, US

(21) Appl. No.: 11/954,871

(22) Filed: Dec. 12, 2007

(30) Foreign Application Priority Data
Jan. 22, 2007 (TW) 096102244

(51) Int. Cl. G06F 21/00; G06F 15/16

(52) U.S. Cl. 726/23

(57) ABSTRACT

A method of filtering junk messages has the steps of generating an implicit code, adding the implicit code to an message to be sent to an addressee, sending the message with the implicit code and a sender's address to the addressee from a sender, and determining whether the implicit code in the message matches a local reference code corresponding to a sender being recorded in an addressee's contact list. The message is correctly received in a normal message box if the implicit code matches the local reference code, otherwise the message is blocked.

### BACKGROUND OF THE INVENTION

1. Field of the Invention

The present invention relates to a method for filtering junk messages, and more particularly to a method that use implicit codes to remove unsolicited junk messages.

2. Description of the Prior Arts

Internet is the most important invention in recent century. Modern civilization depends on Internet very much and most of people in the world can communicate with any remote friend over Internet through email, web phone, Instant messaging and so on.

Email is based on SMTP Internet standard and becomes very popular. However, the numerous unsolicited commercial e-mails, the so-called junk emails, have caused great inconvenience when people open and check their mailboxes. Accordingly, the anti-span technologies are developed.

The anti-span technologies usually use IP black list, domain black list, IP white list, domain white list, keyword black list, the procedures with text mining and data mining method and so forth to eliminate or block the junk emails. Many issued patents such as TW 569106, TW 1247214, TW 1241499, U.S. Pat. No. 6,023,723 and U.S. Pat. No. 6,052,709 also proposed different methods and systems to solve the problem of junk emails.

### SUMMARY OF THE INVENTION

The main objective of the present invention is to provide a method of filtering junk messages that can check whether a message from a sender should be accepted or blocked based on an implicit code.

The steps of the method of the present invention include generating an implicit code, adding the implicit code to an message to be sent to an addressee, sending the message with the implicit code and a sender's address to the addressee from a sender, and determining whether the implicit code in the message matches a local reference code corresponding to a sender being recorded in an addressee's contact list. The message is correctly received in a normal message box if the implicit code matches the local reference code. Otherwise the message is blocked.

When the message is blocked, the method further comprises the steps of directing the message being blocked to a junk message box, determining whether the implicit code in the message should be accepted and moving the message to the normal message box, if the implicit code is accepted, and adding the implicit code together with the sender's address to the addressee's contact list.

Other objectives, advantages and novel features of the invention will become more apparent from the following detailed description when taken in conjunction with the accompanying drawings.

### BRIEF DESCRIPTION OF THE DRAWINGS

FIG. 1 is a flow chart of a method for creating an email and filtering junk emails in accordance with the present invention;

FIG. 2 is a block diagram of a mail system used to practice the method in accordance with the present invention;

FIG. 3 is a flow chart of renewing the implicit code in accordance with the present invention;

FIG. 4 is a simplified flow chart of the method in accordance with the present invention;

FIG. 5 is an example of the email embedded with the implicit code of the present invention; and

FIG. 6 is a block diagram of the mail system showing the junk message filtering and the contact list updating of the present invention.

### DETAILED DESCRIPTION OF THE PREFERRED EMBODIMENTS

The proposed method in accordance with the present invention is suitable for a variety of message communication services such as instant messaging, text messaging transmitted by cell phones, Voice over IP (VoIP) or voice mail. A preferred embodiment of the present invention is applied to filtering of junk emails. The content of an email consists of many fields according to the common standard format like Multipurpose Internet Mail Extensions (MIME), referring to http://www.ietf.org/rfc/rfc2045.txt or http://www.ietf.org/rfc/rfc0821.txt. The main technology of the present invention is to generate an implicit code and embed the code in an existed field or a purposely created field of the email.

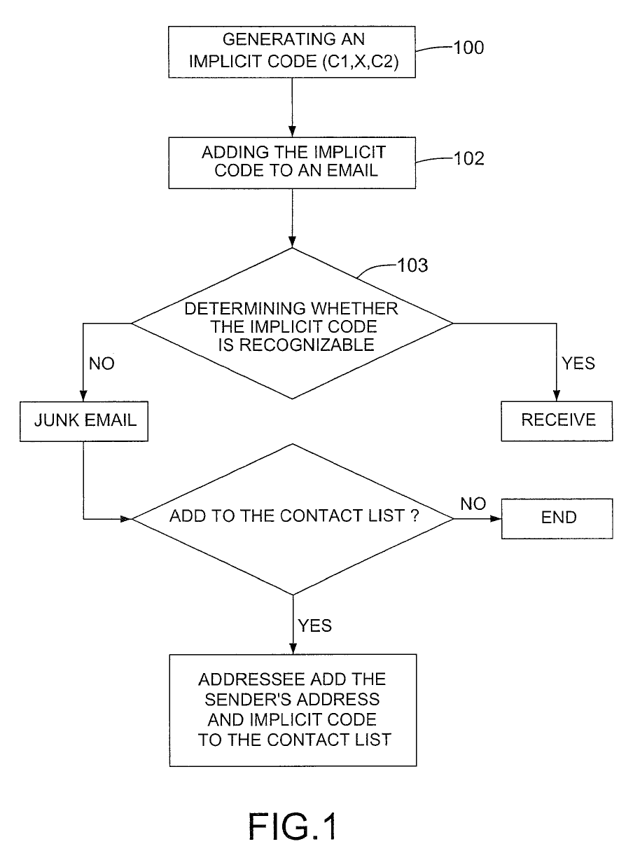

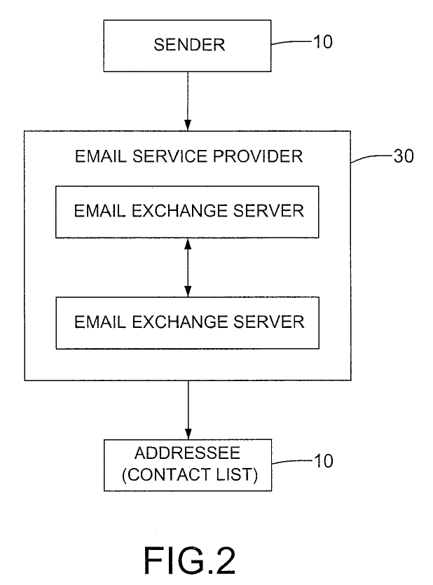

With reference to FIGS. 1 and 2, the method comprises the steps of generating an implicit code (100), adding the implicit code to an email (102), and determining whether the implicit code is recognizable (103).

In the step of generating the implicit code (100), an email sender (10) or an email service provider (30) generates an implicit code. The implicit code can be a computer-generated random, or a serial of designated character or number. In this embodiment, the implicit code consists of three columns (C1, X, C2) with. The descriptions of the three columns are as following.

C1: The first column is implemented by a serial of character, number or others as a recognition code. An addressee can determine whether the email is an approved email or a junk email based the first column C1.

X: The second column represents the status of the email content, and can be a character, like U to indicate the status “Update”.

C2: The third column is a renewing code and can be a serial of character, number or others.

The second and third columns X and C2 are optional parameters. When the second column X indicates the status of update, the third column C2 represents a new recognition code to substitute the original code in first column C1.

In the step of adding the implicit code to the email (102), the implicit code is added in an existed field or a new purposely created field of the email. For example, the sender (100) adds the implicit code in the email, an addressee (20) may recognize the implicit code and successfully receive the email. Adding the implicit code in the email can be implemented by an email exchange server or the sender's email service provider (30), too.

In the step of determining whether the implicit code is recognizable (103), the addressee (20) receives the emails and checks whether the email contains a recognizable implicit code. The addressee (20) may compare the implicit code, particularly the first column C1, with a local reference code to find out whether the implicit code is recognizable. If the implicit code is unrecognizable or no implicit code is found in the email, this email will be blocked, deleted, or directed to a junk mail box. If the addressee (30) searches the junk mail box or gets the information from other resources, the addressee (30) can add the unrecognizable implicit code of a blocked email in a contact list, whereby subsequent emails from this sender will be received correctly.

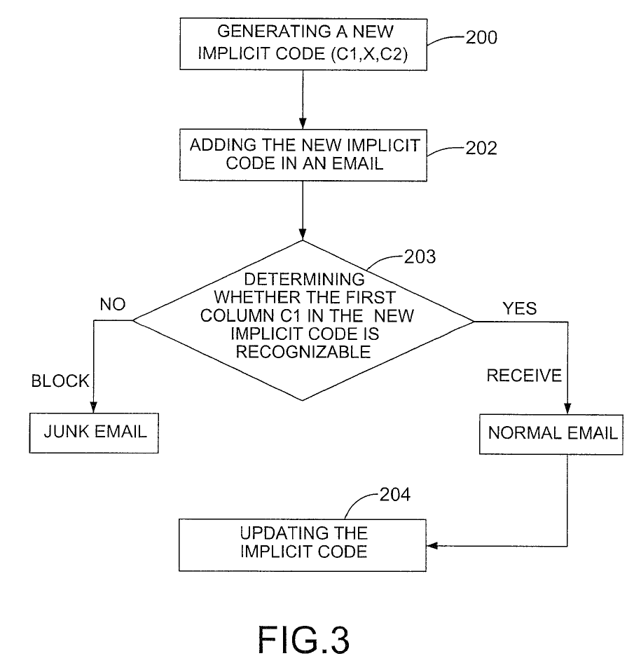

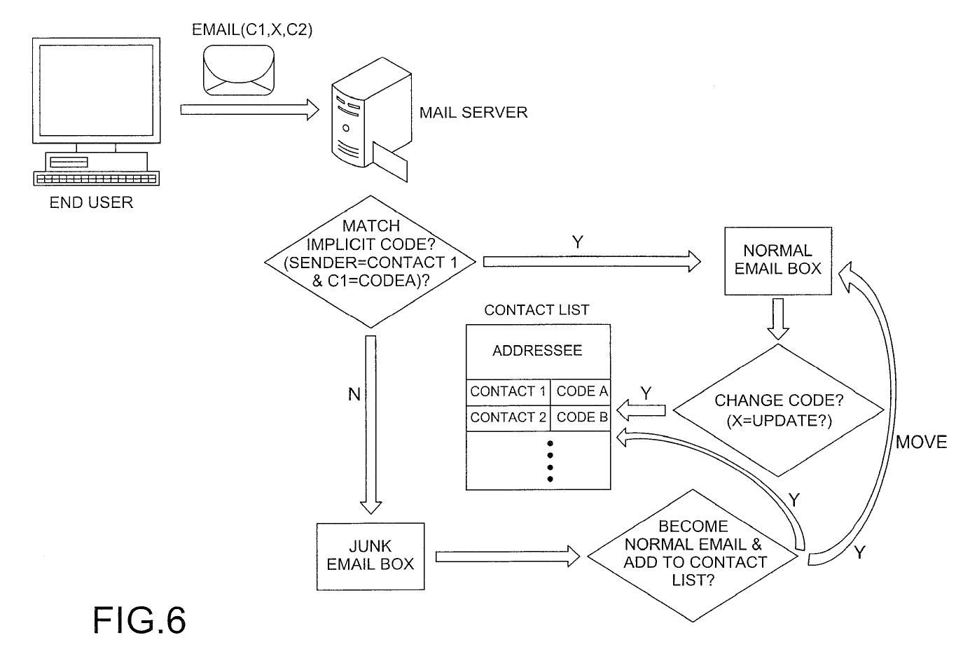

With reference to FIGS. 3 and 6, the implicit code is renewable. The processes of renewing the implicit code comprise the steps of generating a new implicit code (200), adding the new implicit code in an email (201), determining whether the first column C1 in the new implicit code is recognizable (203), and updating the implicit code (204).

In the step of generating the new implicit code (200), a new implicit code with three columns (C1, U, C2) should be established, wherein C1 means the original recognition code, U represents that the email includes a new recognition code to replace the original one, and C2 is the new recognition code. The new implicit code is then added in an email (202) and then transmitted to the addresses (20). When the email is received, the addressee (20) uses the first column C1 of the implicit code to determine whether the email is acceptable. If the first column C1 does not match the local reference code, this email is blocked and deemed as a junk mail. Otherwise, the addressee (20) treats this email as a normal one and receives it correctly. Furthermore, since the implicit code contains an indication “U” in the second column, the addressee (20) replaces the local reference code with the new recognition code C2.

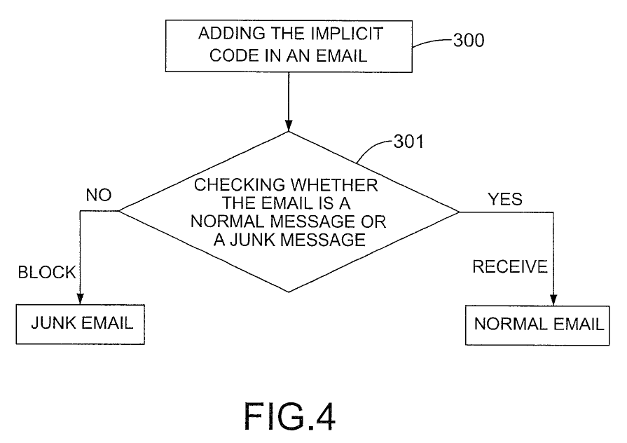

With reference to FIG. 4, when the addressee (20) becomes aware of the sender's implicit code, the sender (10) just adds the implicit code in an email (300). The addressee (20) receives and checks the email to determine whether it is a normal message or a junk message (301) according to the implicit code. The normal message is directed to a normal mail box, while the junk message is blocked.

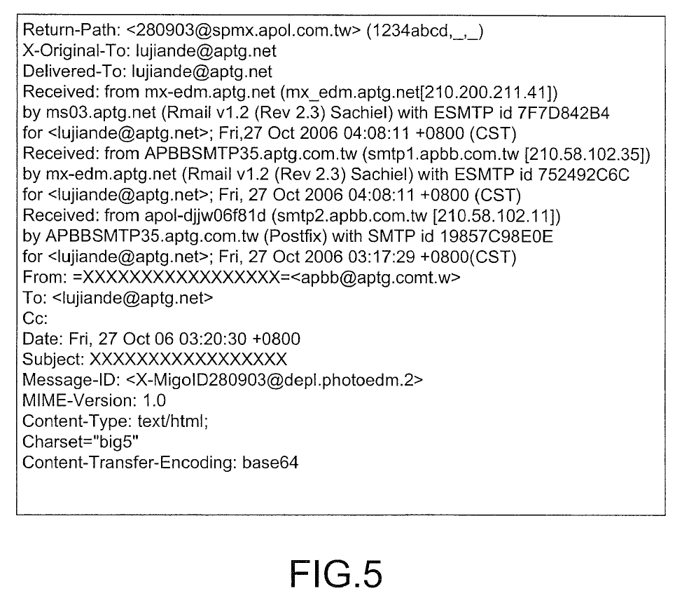

With reference to FIG. 5, the email with the implicit code has many standard fields such ad Return-Path, X-Original-To, Delivered-To. For example, the implicit is (1234abcd,_,_) and is added in the Return-Path field. After the sender (10) completes the email, the original Return-Path:<aaa@bbb.ccc.dd> becomes Return-Path:<aaa@bbb.ccc.dd>(1234abcd,_,_). When the addressee (30) receives the email, the term 1234abcd is compared with a local reference code corresponding to the sender aaa@bbb.ccc.dd being recorded in the addressee's contact list.

The proposed method could direct all the junk email to junk email box as the method was implemented in both sender and addressee sides. Both sides can also reduce the processes to operate email systems. Preferably, the user side only manages the contact list and the server side performs the code operation procedure without junk email filter system.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method for filtering junk messages, the method comprising:
generating an implicit code;
adding the implicit code to an message to be sent to an addressee;
sending the message with the implicit code and a sender's address to the addressee from a sender; and
determining whether the implicit code in the message matches a local reference code corresponding to a sender being recorded in an addressee's contact list, wherein the message is correctly received in a normal message box if the implicit code matches the local reference code, otherwise the message is blocked.

2. The method as claimed in claim 1, wherein the message to be sent is an email and the implicit code is created by either the sender or an email service provider.

3. The method as claimed in claim 2, wherein the implicit code is added in a purposely created field of the email.

4. The method as claimed in claim 2, wherein the implicit code is added in one of standard fields of the email.

5. The method as claimed in claim 1, wherein the implicit code comprises three columns (C1, X, C2), wherein C1 is an original recognition code, X represents the status of the email content and C2 is an renewing code.

6. The method as claimed in claim 1, wherein the message to be sent is an instant message.

7. The method as claimed in claim 1, wherein the message to be sent is a text messaging transmitted by cell phones.

8. The method as claimed in claim 1, wherein the message to be sent is a web phone.

9. The method as claimed in claim 1, wherein the message to be sent is a Voice over IP (VoIP).

10. The method as claimed in claim 1, wherein the method further comprises of steps when the message is blocked:
directing the message being blocked to a junk message box;
determining whether the implicit code in the message should be accepted; and
moving the message to the normal message box, if the implicit code is accepted, and adding the implicit code together with the sender's address to the addressee's contact list.

11. The method as claimed in claim 5, wherein the method further comprises of steps when the message is blocked:
directing the message being blocked to a junk message box;
determining whether the implicit code in the message should be accepted; and
moving the message to the normal message box, if the implicit code is accepted, and adding the implicit code together with the sender's address to the addressee's contact list.

12. The method as claimed in claim 5, wherein the method further comprises the steps of:
checking whether the implicit code contains an update indication in the second column X; and
replacing the original recognition code C1 with the renewing code C2.

13. The method as claimed in claim 11, wherein the method further comprises the steps of:
checking whether the implicit code contains an update indication in the second column X; and
replacing the original recognition code C1 with the renewing code C2.

14. The method as claimed in claim 5, wherein the original recognition code C1 is compared with the local reference code to determine whether the message should be correctly received in the normal message box.
